(19) United States
(12) Patent Application Publication
(10) Pub. No.: US 2019/0362333 A1
(43) Pub. Date: Nov. 28, 2019

(54) USER AUTHENTICATION SYSTEMS AND METHODS

(71) Applicant: Mastercard International Incorporated, Purchase, NY (US)

(72) Inventor: Asheesh Agarwal, Gujarat (IN)

(21) Appl. No.: 16/407,911

(22) Filed: May 9, 2019

(30) Foreign Application Priority Data
May 22, 2018 (SG) 10201804318W

(51) Int. Cl. G06Q 20/32; H04L 29/06; G06Q 20/40

(52) U.S. Cl. CPC G06Q 20/3224; G06Q 20/409; H04L 63/0853

(57) ABSTRACT

A data processing system for authenticating a user is disclosed. The data processing system comprises: a computer processor and a data storage device, the data storage device storing instructions operative by the processor to: receive an authentication request from a user device, the authentication request comprising smart device information for a plurality of smart devices coupled to the user device; look up stored authentication information for the user, the stored authentication information comprising smart device information for a plurality of smart devices associated with the user; and authenticate the user by comparing the smart device information of the authentication request with the stored authentication information.

### CROSS-REFERENCE TO RELATED APPLICATION

This application is a U.S. National Stage filing under 35 U.S.C. § 119, based on and claiming benefits of and priority to Singapore Patent Application No. 10201804318W filed on May 22, 2018. The entire disclosure of the above application is incorporated herein by reference for all purposes

### FIELD OF THE INVENTION

The present disclosure relates to systems and methods for user authentication and in particular to user authentication using information relating to smart devices in the vicinity of a user device.

### BACKGROUND OF THE INVENTION

Many scenarios require user authentication in order to verify the identity of a user and prevent fraud. One common scenario in which user authentication is required is electronic commerce. In many electronic commerce applications users are required to authenticate their identity by inputting information such as passwords, one-time passwords, and personal information. This input of data can be frustrating for users and users may make mistakes when inputting complex data strings for one-time passwords.

However, in order to reduce the risk of fraud in such scenarios it is important that information unique to the true user is used in the authentication process.

### SUMMARY OF THE INVENTION

According to a first aspect of the disclosure invention there is provided a data processing system for authenticating a user. The data processing system comprises: a computer processor and a data storage device, the data storage device storing instructions operative by the processor to: receive an authentication request from a user device, the authentication request comprising smart device information for a plurality of smart devices coupled to the user device; look up stored authentication information for the user, the stored authentication information comprising smart device information for a plurality of smart devices associated with the user; and authenticate the user by comparing the smart device information of the authentication request with the stored authentication information.

According to an embodiment, the authentication request further comprises an indication of a geo-location of the user device and the stored authentication information comprises indications of a plurality of geo-locations, each geo-location having a set of stored smart device information, and the data storage device stores instructions operative by the processor to authenticate the user by comparing the smart device information of the authentication request with set of smart device information corresponding to the geo-location of the user device.

According to an embodiment, the authentication request further comprises an indication of an attribute of the user device, and the stored authentication information for the user further comprises an indication of the attribute of the user device.

According to an embodiment, the smart device information comprises a unique identifier of each of the plurality of smart devices.

According to an embodiment, the data storage device stores instructions operative by the processor to look up an indication of a payment card associated with the user if the authentication is successful.

A data processing system according to any preceding claim wherein the authentication request is a payment transaction authorization request.

According to a second aspect of the present disclosure there is provided a user authentication method comprising: receiving an authentication request from a user device, the authentication request comprising smart device information for a plurality of smart devices coupled to the user device; looking up stored authentication information for the user, the stored authentication information comprising smart device information for a plurality of smart devices associated with the user; and authenticating the user by comparing the smart device information of the authentication request with the stored authentication information.

In an embodiment, the stored authentication information comprises smart device information for at least three smart devices associated with the user and authenticating the user comprises generating an indication that the authentication is successful if the smart device information for at least two smart devices of the plurality of smart devices coupled to the user device matches the smart device information for one of the at least three smart devices associated with the user.

According to a third aspect of the present disclosure there is provided a data processing device for generating a user authentication request. The data processing device comprises: a computer processor and a data storage device, the data storage device storing instructions operative by the processor to: interrogate a plurality of smart devices coupled to the data processing device to determine smart device information; and generate an authentication request comprising the smart device information.

In an embodiment, the data storage device further comprises instructions operative by the computer processor to: determine a geo-location of the user device and wherein the authentication request further comprises an indication of the geo-location of the user device.

In an embodiment, the data processing device further comprises at least one wireless communication interface and wherein the smart devices are coupled to the data processing device via a wireless network.

In an embodiment, the smart device information comprises a unique identifier of each of the plurality of smart devices.

According to a fourth aspect of the present disclosure there is provided a method of generating an authentication request on a user device. The method comprises: interrogating a plurality of smart devices coupled to the user device to determine smart device information; and generating an authentication request comprising the smart device information.

Embodiments of the invention may be implemented as a network of communicating devices (i.e. a “computerized network”). Further embodiments comprise a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

Embodiments of the invention will now be described by way of example only with reference to the following drawings, in which:

FIG. 1 is a block diagram showing a system for user authentication according to an embodiment of the present invention;

FIG. 2 is a block diagram showing functional modules of a user device according to an embodiment of the present invention;

FIG. 3 is a block diagram showing functional modules of an authentication server according to an embodiment of the present invention;

FIG. 4 is a flow chart showing a method of generating an authentication request on a user device according to an embodiment of the present invention;

FIG. 5 is a flow chart showing a method of authenticating a user according to an embodiment of the present invention;

FIG. 6 is a flow chart showing message flows in a method of authenticating a user to open a protected webpage according to an embodiment of the present invention;

FIG. 7 is a flow chart showing message flows in a method of authenticating a user during a payment transaction according to an embodiment of the present invention

FIGS. 8a and 8b are a flow chart showing message flows in a method of generating smart device information for use in authentication methods according to embodiments of the present invention;

FIG. 9 is a block diagram showing a technical architecture of a user device according to an embodiment of the present invention; and

FIG. 10 is a block diagram showing a technical architecture of an authentication server according to an embodiment of the present invention.

### DETAILED DESCRIPTION OF CERTAIN EMBODIMENTS

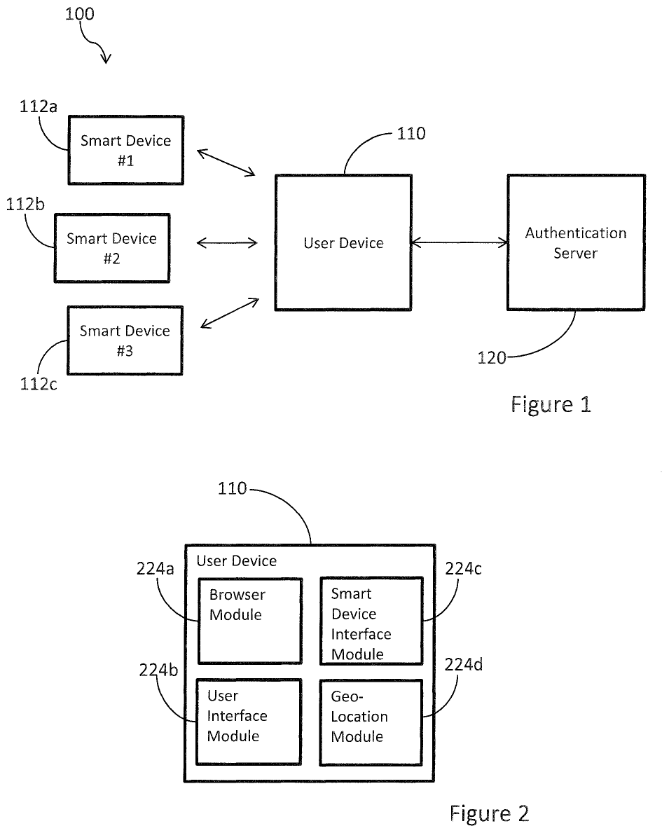

FIG. 1 is a block diagram showing a system for authenticating a user using information relating to smart devices in the vicinity of a user device according to an embodiment of the present invention. As shown in FIG. 1, the system 100 comprises a user device 110 which is coupled to a plurality of smart devices 112a-c. The system further comprises an authentication server 120 which authenticates a user of the user device 110 using information relating to the plurality of smart devices 112a-c. While three smart devices are shown in FIG. 1, it will be appreciated that the actual number of smart devices used in implementing embodiments of the present invention may vary. The user device 110 may communicate with the authentication server 120 over a network such as the internet.

The plurality of smart devices 112a-c are electronic devices such as smart watches, fitness trackers, smart home appliances or other devices which are capable of electronic connection with the user device 110 via a wireless network. The smart devices 112a-c may connect directly to the user device 110 using a wireless protocol such as Bluetooth, alternatively, the smart devices 112a-c may connect either via a wired or wireless network connection to a hub device such as a wireless router and the user device 110 may be coupled to the smart devices 112a-c through the hub device. The communication between the user device 110 and the smart devices 112a-c may be any of the following communication technologies Wi-Fi, Bluetooth, Infra-red, and near-field communication. Different smart devices may communicate with the user device 110 though different communication technologies.

Embodiments are envisaged in which the communication between the user device 110 and the smart devices 112a-c takes place through a server. For example, smart devices from a specific provider may be coupled to a server associated with that provider and the user device 110 or authentication server 120 may communicate with the server to communicate with the smart devices 112a-c. In other embodiments, there may be a common hub through which all smart devices within the user's home are connected and the communication between the user device 110 and the smart devices 112a-c may take place via the common hub.

FIG. 2 is a block diagram showing the functional modules of a user device according to an embodiment of the present invention. As shown in FIG. 2, the user device 110 comprises a browser module 224a, a user interface module 224b, a smart device interface module 224c and a geo-location module 224d. The browser module 224a provides allows a user of the user device 110 to access web pages provided over a network such as the internet. The browser module 224a may implement an internet browser such as Google Chrome, Microsoft Internet Explorer, Microsoft Edge, Apple Safari, Mozilla Firefox, or other browser program. In some embodiments, the browser module 224a may be provided as part of an application such as a mobile payment application or an on-line retailer application. The user interface 224b allows the user to input commands and make selections. The user interface module 224b may be implemented as a touchscreen or as a display and an input module such as a keypad. The smart device interface module 224c allows the user device 110 to couple with the smart devices 112a-c. The smart device interface module 224c may be implemented as a wireless network module which couples either directly or via a hub such as a router with the smart devices 112a-c. The geo-location module 224d is operable to determine the location of the user device 110 and to generate a geolocation indicator indicating the location of the user device 110. The location indication may be for example a set of co-ordinates indicating the location of the user device 110.

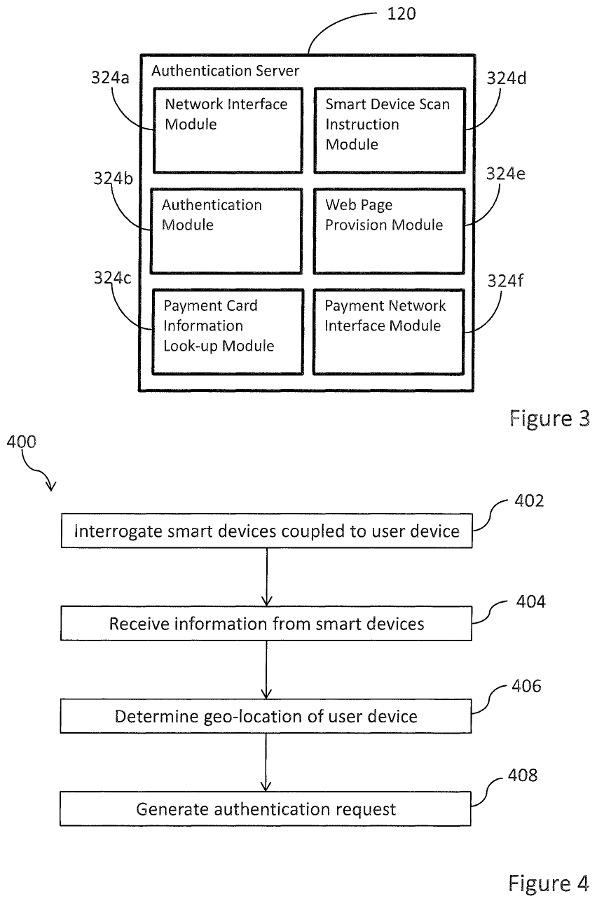

FIG. 3 is a block diagram showing functional modules of an authentication server according to an embodiment of the present invention. As shown in FIG. 3, the authentication server 120 comprises a network interface module 324a, an authentication module 324b, a payment card information look-up module 324c, a smart device scan instruction module 324d, a web page provision module 324e and a payment network interface module 324f. The network interface module 324a allows the authentication server 120 to communicate with the user device 110 over a network such as the internet. The authentication module 324b is operable to authenticate the user of the user device by comparing information of smart devices received from the user device 110 with stored authentication data. The stored authentication data may be stored on the authentication server 120 or may be stored on a database coupled to the authentication server 120. The payment card information look-up module 324c is operable to look up payment card data such as a payment card account number and expiry date using information received from the user device 110 such as the smart device information and the geo-location of the user device 110. The smart device scan instruction module 324d is operable to provide instructions to a browser running on the user device 110 to perform a scan of smart devices coupled to the user device 110. The web page provision module 324e is operable to provide a protected web page to the browser running on the user device 110. The protected web page may be for example an internet banking web page or other web page to which user access is controlled. The payment network interface module 324f is operable to interact with a payment network during the processing to authorize payment transactions. In some embodiments, the authentication server 120 may be implemented as an issuer server of a payment network and may be operable to authenticate a user as part of a payment transaction authorization process. Alternatively, the authentication server 120 may be implemented as a merchant server.

FIG. 4 is a flow chart showing a method of generating an authentication request on a user device according to an embodiment of the present invention. The method 400 shown in FIG. 4 is carried out by the user device 110 shown in FIG. 2.

In step 402, the smart device interface module 224c of the user device 110 interrogates the smart devices 112a-c coupled to the user device 110. Step 402 may comprise the user device 110 sending a request to each of the smart devices 112a-112c for device identifiers, device names, indications of device capabilities, or other unique attributes of the smart devices 112a-c coupled to the user device 110.

In step 404, the smart device interface module 224c of the user device 110 receives smart device information from each of the smart devices 112a-c. As mentioned above, the smart device information comprises unique attributes of the smart devices 112a-c coupled to the user device 110, therefore, the smart device information for the plurality of smart devices provides a unique “fingerprint” that corresponds to the set of devices coupled to the user device 110.

In step 406, the geo-location module 224d of the user device 110 determines the geo-location of the user device 110.

In step 408, the browser module 224a of the user device 110 generates an authentication request which comprises the smart device information and an indication of the geo-location of the user device 110. The authentication request is sent to the authentication server 120 to authenticate the user of the user device 110.

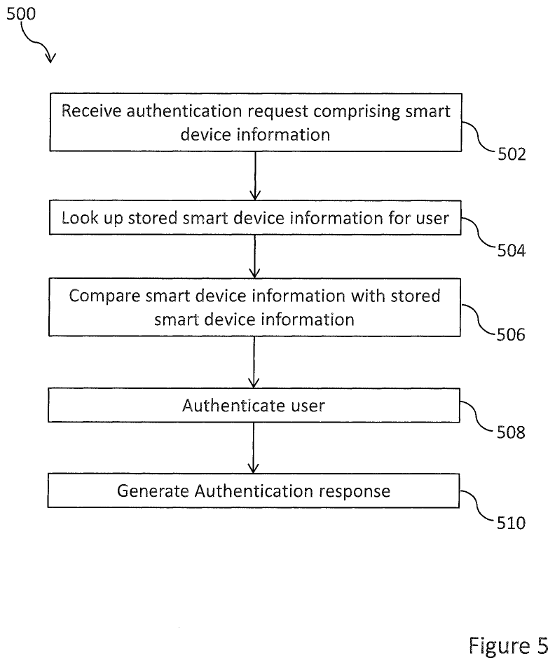

FIG. 5 is a flow chart showing a method of authenticating a user according to an embodiment of the present invention. The method 500 shown in FIG. 5 is carried out by the authentication server 120 shown in FIG. 3.

In step 502, the network interface module 324a of the authentication server 120 receives an authentication request from the user device 110. The authentication request comprises smart device information which as described above indicates attributes of the smart devices 112a-c coupled to the user device 110. As described above with reference to FIG. 4, the authentication request may also comprise an indication of the geo-location of the smart device 110.

In step 504, the authentication module 324b of the authentication server 120 looks up smart device information for the user. The authentication request received from the user device 110 may contain a user identifier such as a log-in name or an account number associated with the user and the authentication module 324b may use the user identifier to look up stored smart device information for the user. The authentication request may comprise a unique smart device identifier or user identifier assigned by a smart device after its activation.

In some embodiments, several sets of smart device information are stored for a user with each set being associated with a geo-location or a range of geo-locations. Thus, for example, a geo-location corresponding to a user's home may be associated with a set of smart device information corresponding to smart devices located at the user's home, and other geo-locations may be associated with a set of smart devices which the user carries with them such as a smart watch device and a headset device.

In step 506, the authentication module 324b of the authentication server 120 compares the received smart device information with the stored smart device information.

In step 508, the authentication module 324b of the authentication server 120 authenticates the user using the result of the comparison carried out in step 506.

In step 510, the authentication module 324b of the authentication server 120 generates an authentication response indicating the result of the authentication.

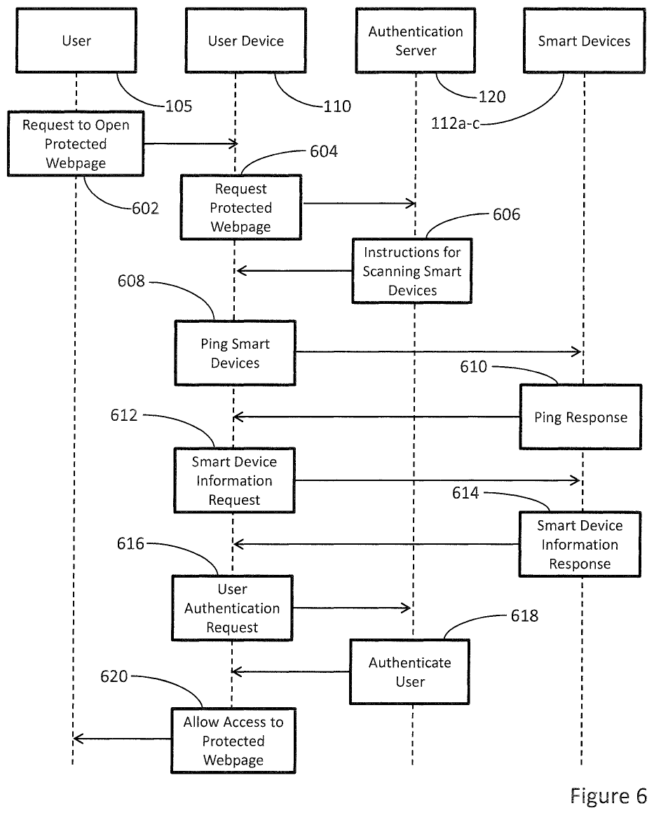

FIG. 6 is a flow chart showing message flows in a method of authenticating a user to open a protected webpage according to an embodiment of the present invention. The method shown in FIG. 6 is carried out by a user 105 of the user device 110 and FIG. 6 shows message flows between the user device 110, the authentication server 120 and the smart devices 112a-c.

In this example implementation, the smart device information is used to authenticate the user 105 to access a protected web page provided by the authentication server 120. The protected webpage may be for example an internet banking website.

Initially, the user 105 makes a request 602 to open the protected webpage. The request is entered by the user 105 into the browser module 224a of the user device 110 using the user interface module 224b.

The browser module 224a of the user device 110 then generates a request 604 for the protected webpage which is sent to the authentication server 120. In generating the request 604, the geo-location module 224d of the user device 110 may determine the geo-location of the user device 110. Thus, the request 604 for the protected webpage may include an indication of the geo-location of the user device 110. In response to receiving the request 604, the smart device scan module 324d of the authentication server 120 generates instructions 606 for scanning smart devices which are sent to the user device 110. The smart device scan module 324d of the authentication server 120 uses the indication of the geo-location of the user device 110 in the generation of the instructions 606 for scanning smart devices. The authentication server 120 uses the indication of the geo-location of the user device 110 to look up a set of smart devices which are associated with that geo-location.

The instructions 606 for scanning smart devices comprise the following: In general the instructions will include the set of steps required to connect with all the smart devices near to the user device 110. For example, an instruction for a connecting to one smart device may include a set of application programming interface (API) calls to ping the smart device and thereby retrieve smart device information. This instruction could also be in the form of script or set of Java calls or any other software paradigm to connect with a smart device. The instructions may differ for each smart device depending upon the smart device manufacturer.

In response to receiving the instructions 606 for scanning smart devices, the user device 110 begins a scan of smart devices in the vicinity. The scan involves the smart device interface module 224c of the user device 110 generating a ping signal 608 which is sent to all of the smart devices 112a-c. The ping signal 608 may cause smart devices in the vicinity to couple with the user device 110. The smart device request/ping information is determined from the instructions 606 for scanning smart devices. The instructions 606 for scanning smart devices comprise indications of the steps which are required to ping the smart device. The instructions 606 for scanning smart devices can be in the form of API calls or scripts or another software paradigm. In response to receiving the ping signal 608 each of the smart devices 112a-c generates a ping response 610. The ping responses 610 are received by the smart device interface module 224c of the user device 110. The smart device interface module 224c of the user device 110 uses the ping responses 610 to identify the network addresses of the smart devices 112a-c and sends a smart device information request 612 to each of the smart devices 112a-c. In response to the smart device information request 612 each smart device 112a-c sends a smart device information response 614 to the user device.

After receiving the smart device information responses 614, the browser module 224a of the user device 110 generates a user authentication request 616. It is noted that responses may not be received from all of the smart devices in the vicinity of the user device 110. For example, depending upon various conditions such as non-availability of a smart device, the smart device being switched off, and a particular smart device not being linked to the current geo-location of the user device 110, a response may not be received from that smart device. The user authentication request 616 comprises indications of the smart device information of the plurality of smart devices 112a-c. The user authentication request 616 may also comprise information of the user device 110 such as the geo-location of the user device and information an indication of an identifier of the user device.

The user authentication request 616 is send to the authentication server 120 by the browser module 224a of the user device 110. After receiving the user authentication request 616, the authentication module 324b of the authentication server 120 authenticates the user 105. This authentication process comprises comparing the smart device information from the user authentication request 616 with stored smart device information for the user. If the smart device information in the user authentication request 616 matches the stored smart device information for the user, then a positive authentication response is generated by the authentication module 324b of the authentication server 120. The matching process may comprise generating a positive authentication response is, for example, two out of three smart devices are matched. In some embodiments, a particular smart device may be given a higher weighting than other smart devices in generating the authentication response. In such embodiments a positive authentication response may be generated if one device having a high weighting out of three devices is matched. In some embodiments information of the user device 110 may be used in the authentication in addition to the information of the smart devices 112a-c.

Following successful authentication of the user, the web page provision module 324e of the authentication server 324e provides the protected webpage to the browser module 224a of the user device as part of an authentication response 618.

Then, the user 105 is allowed access to the protected webpage 620 through the browser module 224a of the user device 110.

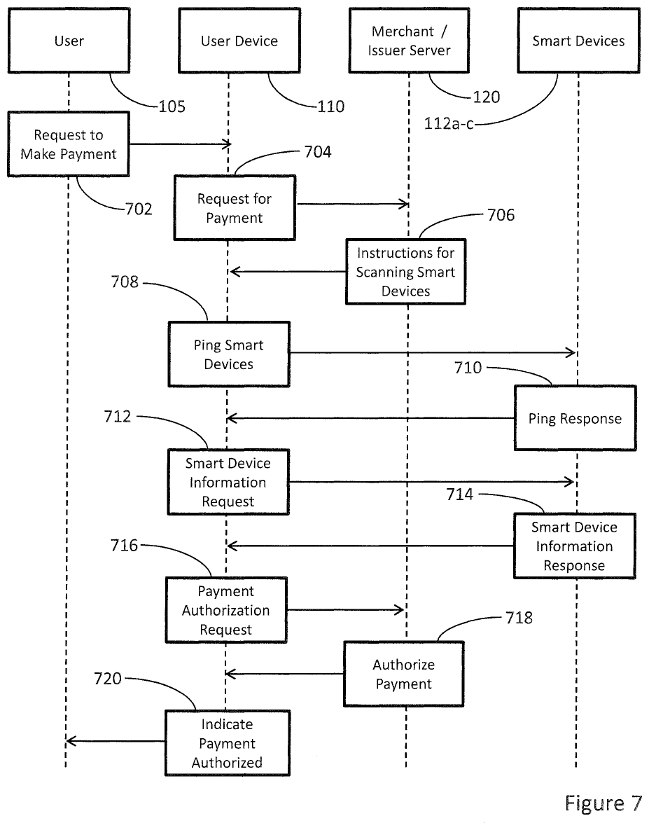

FIG. 7 is a flow chart showing message flows in a method of authenticating a user during a payment transaction according to an embodiment of the present invention. The method shown in FIG. 7 is carried out by a user 105 of the user device 110 and FIG. 7 shows message flows between the user device 110, the authentication server 120 and the smart devices 112a-c.

The authentication server 120 may be implemented as either by a merchant server or as an issuer server. If the authentication server 120 is implemented as a merchant server then merchant will not ask for any secondary authentication information before submitting the payment request to the acquirer. If the authentication server 120 is implemented by issuer server then the issuer will not ask for any secondary authentication information to verify user's presence and consent for this transaction.

In this example implementation, the smart device information is used to authenticate a payment made by the user 105 to on an electronic commerce website provided by a merchant which may be the operator of the authentication server 120. Alternatively, the authentication server 120 may be operated by an issuer of a payment card.

Initially, the user 105 inputs a request 702 to make a payment. The user 105 may have already logged into an on-line merchant website and be ready to make a payment. The request 702 to make the payment is entered by the user 105 into the browser module 224a of the user device 110 using the user interface module 224b.

The browser module 224a of the user device 110 then generates a request 704 for payment which is sent to the authentication server 120 which is associated with the merchant. In generating the request 704, the geo-location module 224d of the user device 110 may determine the geo-location of the user device 110. Thus, the request 704 for the protected webpage may include an indication of the geo-location of the user device 110.

In response to receiving the request 704, the smart device scan module 324d of the authentication server 120 generates instructions 706 for scanning smart devices which are sent to the user device 110. The smart device scan module 324d of the authentication server 120 uses the indication of the geo-location of the user device 110 in the generation of the instructions 706 for scanning smart devices.

The instructions 706 for scanning smart devices may comprise the following. In general the instructions will include the set of steps required to connect with all the smart devices near to the user device 110. For example, an instruction for a connecting to one smart device may include a set of application programming interface (API) calls to ping the smart device and thereby retrieve smart device information. This instruction could also be in the form of script or set of Java calls or any other software paradigm to connect with a smart device. The instructions may differ for each smart device depending upon the smart device manufacturer.

In response to receiving the instructions 706 for scanning smart devices, the user device 110 begins a scan of smart devices coupled to it. The scan involves the smart device interface module 224c of the user device 110 generating a ping signal 708 which is sent to all of the smart devices 112a-c coupled to the user device 110. In response to receiving the ping signal 708 each of the smart devices 112a-c generates a ping response 710. The ping responses 710 are received by the smart device interface module 224c of the user device 110. The smart device interface module 224c of the user device 110 uses the ping responses 710 to identify the network addresses of the smart devices 112a-c and sends a smart device information request 712 to each of the smart devices 112a-c. In response to the smart device information request 712 each smart device 112a-c sends a smart device information response 714 to the user device.

After receiving the smart device information responses 714, the browser module 224a of the user device 110 generates a payment authorization request 716. The payment authorization request 716 comprises indications of the smart device information of the plurality of smart devices 112a-c. In some cases, may not be received from all of the smart devices 112a-c depending on various conditions. For example, non-availability of smart device, smart device is switched off, smart device is not attached with user device's current geo-location. The payment authorization request 716 may also comprise information of the user device 110 such as the geo-location of the user device and information an indication of an identifier of the user device.

In some embodiments, the payment authorization request 716 may comprise an indication of a payment card of the user 105. In other embodiments, the payment card information look up module 324c of the authentication server 120 determines payment card information using the information of the smart devices 112a-c included in the payment authorization request 716. The geo-location of the user device and the indication of an identifier of the user device may also be used in the determination of payment card information.

Then, the authentication module 324b of the authentication server 120 authenticates the payment by confirming that the smart device information included within the payment authorization request matches stored information. If there is a match, the authentication module 324b of the authentication server generates an indication 718 that the payment has been authorized. In some embodiments, the payment network interface module 324f of the authentication server 120 sends messages over a payment network to authorize the payment transaction.

In the event that there is no match, the authentication server 120 may prompt the user to authorize the payment through another method, for example by manually entering the payment card details.

The indication 718 that the payment has been authorized is received by the browser module 224a of the user device 110. In response to receiving the indication 718, the user interface module 224b of the user device 110 generates an indication 720 to the user that the payment has been authorized.

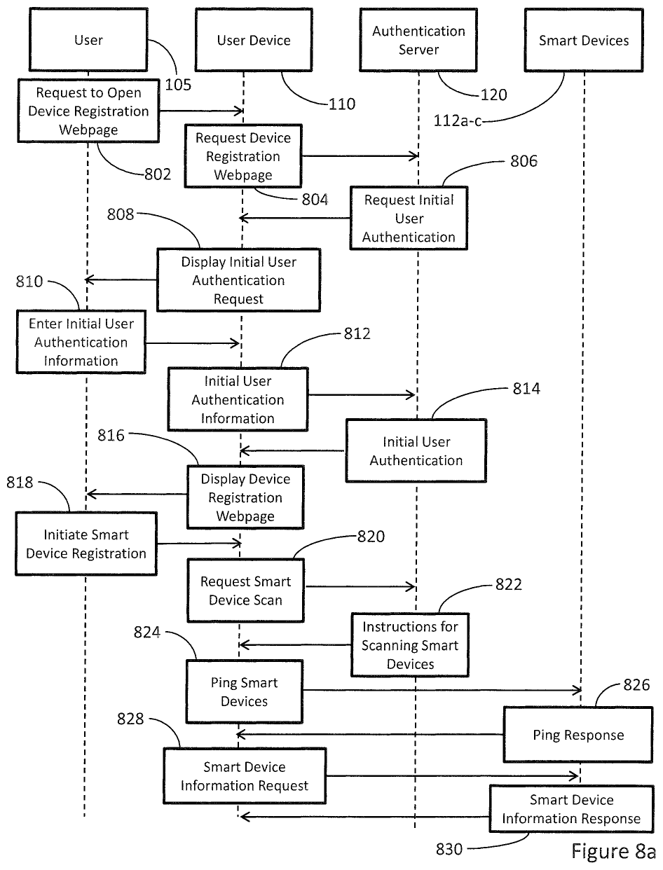

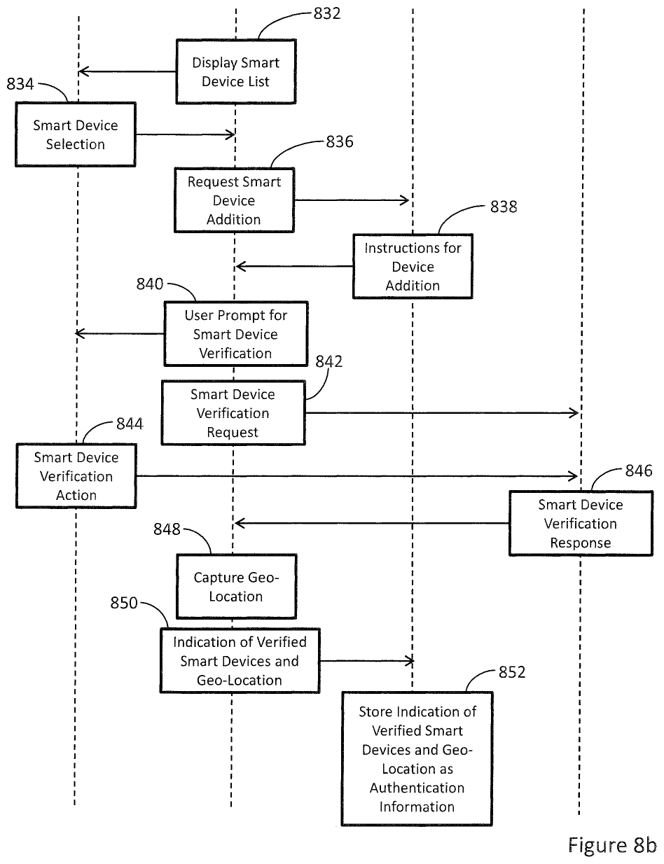

FIGS. 8a and 8b are a flow chart showing message flows in a method of generating smart device information for use in authentication methods according to embodiments of the present invention. The method involves the user adding smart devices to be included in the smart device information.

Initially, the user 105 makes a request 802 to open a device registration webpage. The request 802 is received by the user device 110. In response to receiving the request 802, the browser module 224a of the user device 110 makes a request 804 to the authentication server 120 for the device registration webpage.

In response to the request 804 for the device registration webpage, the webpage provision module 324e of the authentication server 120 makes a request 806 to the browser module 224a of the user device 110 for initial user authentication. The browser module 224a of the user device 110 displays an initial user authentication request 808 to the user. The initial user authentication request 808 may be a request for log-in information. In some embodiments, the user 105 may be provided with a web link or one-time password to initiate the device registration process.

In response to the initial user authentication request 808, the user 105 enters initial user authentication information 810 into the user interface module 224b of the user device 110. This initial user authentication information 812 is sent by the browser module 224a of the user device 110 to the authentication server 120. In response to receiving the initial user authentication information 812, the authentication module 324b of the authentication server 120 performs an initial user authentication 814.

If the initial user authentication 814 is successful, the authentication server 120 provides the browser module 224a of the user device 110 with a device registration webpage 816 which is displayed to the user 105. The user 105 then inputs an indication 818 to initiate smart device registration. In response to the input of the indication 818 to initiate smart device registration, the browser module 224a of the user device 110 sends a request 820 for a smart device scan to the authentication server 120. In response to the request, the smart device scan instruction module 324d of the authentication server 120 sends instructions 822 for scanning smart devices to the user device 110.

In response to receiving the instructions 822 for scanning smart devices, the user device 110 begins a scan of smart devices in the vicinity. The scan involves the smart device interface module 224c of the user device 110 generating a ping signal 824 which is sent to all of the smart devices 112a-c coupled to the user device 110. In response to receiving the ping signal 824 each of the smart devices 112a-c generates a ping response 826. The ping responses 826 are received by the smart device interface module 224c of the user device 110. The smart device interface module 224c of the user device 110 uses the ping responses 826 to identify the network addresses of the smart devices 112a-c and sends a smart device information request 828 to each of the smart devices 112a-c. In response to the smart device information request 828 each smart device 112a-c sends a smart device information response 828 to the user device 110.

Once the scan of the smart devices 112a-c is completed, the user interface module 224b of the user device 110 displays a smart device list 832. In response to this, the user 105 makes a selection of the smart devices to be used for authentication. The user 105 inputs the smart device selection 834 into the user interface module 224b of the user device 110.

In response to the entry of the smart device selection 834 by the user 105, the browser module 224a of the user device 110 sends a request for smart device addition 836 to the authentication server 120. In response to the request for smart device addition 836, the smart device scan instruction module 324d of the authentication server 120 sends instructions for device addition 838 to the user device.

The instructions for device addition 838 include indications to verify the smart devices 112a-c and may include instructions to verify the smart devices by, for example, the user tapping on the smart devices, or interacting with the smart devices in a specified way, the instructions may cause the smart devices to display a code which the user is then prompted to enter into the user device 110. The user 105 may be prompted to enter an identifier such as the International Mobile Equipment Identity (IMEI) of the device; a unique identifier of the device; or the media access control (MAC) address of the device.

As shown in FIG. 8b, the user device 110 may show a prompt 840 to the user 105 for smart device verification. This prompt may be a request to the user to interact with the smart device. As shown in FIG. 8b, a smart device verification request 842 is sent to the smart device by the smart device interface module 224c of the user device 110. The user 105 performs the smart device verification action 844 such as tapping on the smart device and in response to the smart device verification action 844, the smart device sends a smart device verification response 846 to the smart device interface module 224c of the user device 110.

This process is repeated for each of the smart devices selected by the user.

The geo-location module 224d of the user device 110 captures the geo-location 848 of the user device 110.

Then, the browser module 224a of the user device 110 sends an indication of the verified smart devices and the geo-location to the authentication server 120. The authentication server 120 stores the indications of the verified smart devices and the geo-location as authentication information.

It is noted that the process may be repeated at different geo-locations so that the use has authentication information which corresponds to different geo-locations.

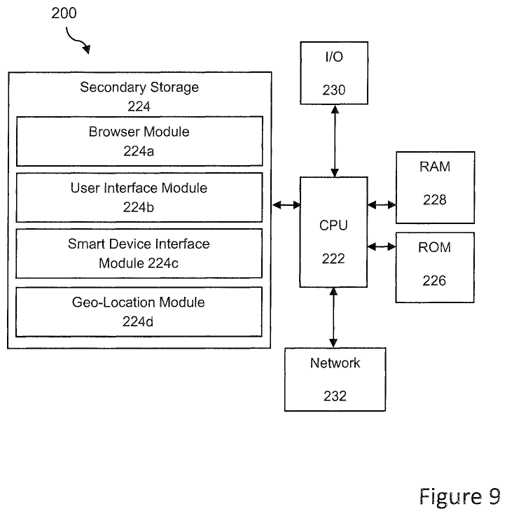

FIG. 9 is a block diagram showing a technical architecture of a user device according to an embodiment of the present invention. The technical architecture 200 of the user device 110 is for performing steps of exemplary methods described above. Typically, the methods are implemented by a computing device having a data-processing unit. The block diagram as shown in FIG. 9 illustrates a technical architecture 200 of a computing device which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 200 may further comprise input/output (I/O) devices 230, and network connectivity devices 232.

The secondary storage 224 is typically comprised of one or more disk drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a browser module 224a, a user interface module 224b, a smart device interface module 224c, and a geo-location module 224d comprising non-transitory instructions operative by the processor 222 to perform various operations of the method of the present disclosure. As depicted in FIG. 9, the modules 224a -224d are distinct modules which perform respective functions implemented by the user device 110. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a -224d is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

The I/O devices may include liquid crystal displays (LCDs), touch screen displays, keyboards, keypads, switches, dials, mice, track balls, voice recognizers, card readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the method operations described herein. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

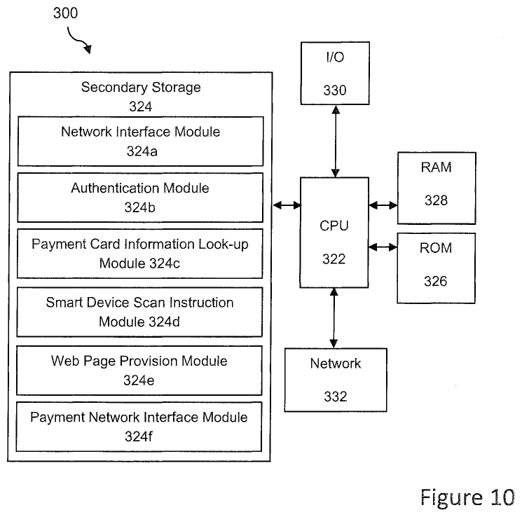

FIG. 10 is a block diagram showing a technical architecture of an authentication server according to an embodiment of the present invention. The technical architecture 300 of the authentication server 120 is for performing steps of exemplary methods described above. Typically, the methods are implemented by a number of computers each having a data-processing unit. The block diagram as shown in FIG. 10 illustrates a technical architecture 300 of a computer which is suitable for implementing one or more embodiments herein.

The technical architecture 300 includes a processor 322 (which may be referred to as a central processor unit or CPU) that is in communication with memory devices including secondary storage 324 (such as disk drives), read only memory (ROM) 326, random access memory (RAM) 328. The processor 322 may be implemented as one or more CPU chips. The technical architecture 300 may further comprise input/output (I/O) devices 330, and network connectivity devices 332.

The secondary storage 324 is typically comprised of one or more disk drives or tape drives and is used for non-volatile storage of data and as an over-flow data storage device if RAM 328 is not large enough to hold all working data. Secondary storage 324 may be used to store programs which are loaded into RAM 328 when such programs are selected for execution. In this embodiment, the secondary storage 324 has a network interface module 324a, an authentication module 324b, a payment card information look-up module 3224c, a smart device scan instruction module 324d, a web page provision module 324e, and a payment network interface module 224f comprising non-transitory instructions operative by the processor 322 to perform various operations of the method of the present disclosure. As depicted in FIG. 10, the modules 324a -324f are distinct modules which perform respective functions implemented by the authentication server 120. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 324a -324f is described herein, these may alternatively be implemented as one or more hardware modules (such as field-programmable gate array(s) or application-specific integrated circuit(s)) comprising circuitry which implements equivalent functionality to that implemented in software. The ROM 326 is used to store instructions and perhaps data which are read during program execution. The secondary storage 324, the RAM 328, and/or the ROM 326 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (VViMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the method operations described herein. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 300, at least one of the CPU 322, the RAM 328, and the ROM 326 are changed, transforming the technical architecture 300 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 300 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 300 to provide the functionality of a number of servers that is not directly bound to the number of computers in the technical architecture 300. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Whilst the foregoing description has described exemplary embodiments, it will be understood by those skilled in the art that many variations of the embodiments can be made in accordance with the appended claims.

1. A data processing system for authenticating a user, the data processing system comprising:
a computer processor and a data storage device, the data storage device storing instructions operative by the processor to:
receive an authentication request from a user device, the authentication request comprising smart device information for a plurality of smart devices coupled to the user device;
look up stored authentication information for the user, the stored authentication information comprising smart device information for a plurality of smart devices associated with the user; and
authenticate the user by comparing the smart device information of the authentication request with the stored authentication information.

2. A data processing system according to claim 1, wherein the authentication request further comprises an indication of a geo-location of the user device and the stored authentication information comprises indications of a plurality of geo-locations, each geo-location having a set of stored smart device information, and the data storage device stores instructions operative by the processor to authenticate the user by comparing the smart device information of the authentication request with set of smart device information corresponding to the geo-location of the user device.

3. A data processing system according to claim 1, wherein the authentication request further comprises an indication of an attribute of the user device, and the stored authentication information for the user further comprises an indication of the attribute of the user device.

4. A data processing system according to claim 1, wherein the smart device information comprises a unique identifier of each of the plurality of smart devices.

5. A data processing system according to claim 1, wherein the data storage device stores instructions operative by the processor to look up an indication of a payment card associated with the user if the authentication is successful.

6. A data processing system according to claim 1 wherein the authentication request is a payment transaction authorization request.

7. A user authentication method comprising:
receiving an authentication request from a user device, the authentication request comprising smart device information for a plurality of smart devices coupled to the user device;
looking up stored authentication information for the user, the stored authentication information comprising smart device information for a plurality of smart devices associated with the user; and
authenticating the user by comparing the smart device information of the authentication request with the stored authentication information.

8. A method according to claim 7, wherein the stored authentication information comprises smart device information for at least three smart devices associated with the user and authenticating the user comprises generating an indication that the authentication is successful if the smart device information for at least two smart devices of the plurality of smart devices coupled to the user device matches the smart device information for one of the at least three smart devices associated with the user.

9. A method according to claim 7, wherein the authentication request further comprises an indication of a geo-location of the user device and the stored authentication information comprises indications of a plurality of geo-locations, each geo-location having a set of stored smart device information, and the method comprises authenticating the user by comparing the smart device information of the authentication request with set of smart device information corresponding to the geo-location of the user device.

10. A method according to claim 7, wherein the authentication request further comprises an indication of an attribute of the user device, and the stored authentication information for the user further comprises an indication of the attribute of the user device.

11. A method according to claim 7, wherein the smart device information comprises a unique identifier of each of the plurality of smart devices.

12. A method according to claim 7, further comprising looking up an indication of a payment card associated with the user if the authentication is successful.

13. A method according to claim 7, wherein the authentication request is a payment transaction authorization request.

14. A data processing device for generating a user authentication request, the data processing device comprising:
a computer processor and a data storage device, the data storage device storing instructions operative by the processor to:
interrogate a plurality of smart devices coupled to the data processing device to determine smart device information; and
generate an authentication request comprising the smart device information.

15. A data processing device according to claim 14, wherein the data storage device further comprises instructions operative by the processor to determine a geo-location of the user device and wherein the authentication request further comprises an indication of the geo-location of the user device.

16. A data processing device according to claim 12, wherein the smart device information comprises a unique identifier of each of the plurality of smart devices.

17. A method of generating an authentication request on a user device, the method comprising:
interrogating a plurality of smart devices coupled to the user device to determine smart device information; and
generating an authentication request comprising the smart device information.

18. A method according to claim 17, further comprising determining a geo-location of the user device and wherein the authentication request further comprises an indication of the geo-location of the user device.

19. A method according to claim 17, wherein the smart device information comprises a unique identifier of each of the plurality of smart devices.

20. A non-transitory computer readable medium carrying computer executable instructions which when executed on at least one processor cause the at least one processor to carry out a method comprising:
receiving an authentication request from a user device, the authentication request comprising smart device information for a plurality of smart devices coupled to the user device;
looking up stored authentication information for the user, the stored authentication information comprising smart device information for a plurality of smart devices associated with the user; and
authenticating the user by comparing the smart device information of the authentication request with the stored authentication information.
